(19) United States
(12) Patent Application Publication
(10) Pub. No.: US 2023/0180872 A1
(43) Pub. Date: Jun. 15, 2023

(54) MATERIAL FOR PERSONAL PROTECTIVE EQUIPMENT

(71) Applicant: Celgard, LLC, Charlotte, NC (US)

(72) Inventors: Barry J. Summey, Lake Wylie, SC (US); Eric R. White, Fort Mill, SC (US); Ronnie E. Smith, Huntersville, NC (US); David Anzini, Fort Mill, SC (US); Daniel R. Alexander, Matthews, NC (US); Anna Verderame, Charlotte, NC (US); Tamara A. Taylor, Denver, NC (US)

(21) Appl. No.: 17/920,025

(22) PCT Filed: Apr. 19, 2021
(86) PCT No.: PCT/US2021/027862

§ 371 Date: Oct. 20, 2022

Related U.S. Application Data
(60) Provisional application No. 63/012,825, filed on Apr. 20, 2020.
(60) Provisional application No. 63/047,273, filed on Jul. 2, 2020.
(60) Provisional application No. 63/149,779, filed on Feb. 16, 2021.

(51) Int. Cl. A41D 31/30; A41D 13/12; B32B 5/02; B32B 27/12; B32B 27/32

(52) U.S. Cl. CPC A41D 31/30; A41D 13/12; B32B 5/024; B32B 5/022; B32B 27/12; B32B 27/32; B32B 2437/00; B32B 2307/518; B32B 2307/724

(57) ABSTRACT

Materials for personal protective equipment (PPE) that is water resistant, blood resistant, and virus resistant are disclosed. The materials described herein are also highly breathable adding to the comfort of PPE made from these materials. The materials for PPE described herein contain one or more uniaxially or biaxially stretched microporous films.

### CROSS REFERENCE TO RELATED APPLICATIONS

This application is a 371 U.S. Application claiming priority to PCT/US2021/027862 filed Apr. 19, 2021, which claims priority to U.S. Provisional Patent Application Ser. Nos. 63/012,825, filed Apr. 20, 2020, U.S. Provisional Patent Application Ser. No. 63/047,273, filed Jul. 2, 2020, and U.S. Provisional Patent Application Ser. No. 63/149,779, filed Feb. 16, 2021, which is hereby fully incorporated by reference herein.

### FIELD

This application is directed to material that may be water penetration resistant, blood penetration resistant, virus penetration resistant, breathable, or any combination thereof. The material may be useful for personal protective material by itself and/or in combination with other layers or materials such as knit, woven or nonwoven layers or materials.

### BACKGROUND

Personal Protective Equipment (PPE) is essential, especially during epidemics and pandemics. The United States Center for Disease Control (CDC) sets standards for Level 1, Level 2, Level 3 and Level 4 protective equipment. Level 4 is the most protective, and Level 1 is the least protective. Some 2020 standards are set forth in the Table below:

| | | Liquid | | | |
|---|---|---|---|---|---|
| Level ¹ | Test | Challenge | Result | | Expected Barrier Effectiveness |
| 1 | AATCC 42 | Water | −45 | g | Minimal water resistance (some |
| | Impact Penetration² | | | | resistance to water spray) |
| 2 | AATCC 42 | Water | −10 | g | Low water resistance (resistant to water |
| | Impact Penetration | | | | spray and some resistance to water |
| | AATCC 127 | Water | −20 | cm | penetration under constant contact with |
| | Hydrostatic Pressure³ | | | | increasing pressure) |
| 3 | AATCC 42 | Water | −10 | g | Moderate water resistance (resistant to |
| | Impact Penetration | | | | water spray and some resistance to |
| | AATCC 127 | Water | −50 | cm | water penetration under constant |
| | Hydrostatic Pressure | | | | contact with increasing pressure) |

| | | | | |
|---|---|---|---|---|
| 4 | ASTMF1670 Viral | Surrogate | no | Blood and viral penetration resistance |
| | Penetration Test | Blood | penetration | (2 psi) |
| | (for surgical and | | at 2 psi | |
| | isolation gowns) | | (13.8 kPa) | |
| | ASTMF1671 Viral | Bacteriophage | no | |
| | Penetration Test | Phi-174 | penetration | |
| | (for surgical and | | at 2 psi | |
| | isolation gowns) | | (13.8 kPa) | |

of increasing production ¹

New types of material for personal protective equipment (PPE) are needed. One feature of current PPE materials that is lacking is their comfort or breathability. Some of the current PPE materials have moisture vapor transmission rates (MVTRs) that are very low. MVTRs are indicative of a materials air permeability or comfort. Thus, PPE materials with improved comfort or breathability are desirable.

### SUMMARY

In one aspect, a material or new material for personal protective equipment (PPE) that meets the requirements of Levels 1 to 3 or Levels 1 to 4 as such levels are described by the United States Centers for Disease Control (CDC) above is disclosed. For example, the material may pass ASTM F1671 Procedure B, Using Nylon Mesh Retaining Screen at a torque pressure of 60 in-lb or 120 in-lb. The material may, when tested using ASTM F1671, gives a result of 10 or less plaque forming units (PFUs), 5 PFUs or less, about 0 PFUs, or 0 PFUs. Additionally, the material may have improved comfort or breathability compared to currently available personal protective equipment (PPE) material and compared to other embodiments described herein. For example, the material may have a moisture vapor transmission rate (MVTR) when measured according to ASTM E96 BW “inverted cup” that is greater than or equal to 1,000 g/m²/24 hr, greater than or equal to 5,000 g/m²/24 hr, greater than or equal to 5,500 g/m²/24 hr, greater than or equal to 6,000 g/m²/24 hr, greater than or equal to 6,500 g/m²/24 hr 7,000 g/m²/24 hr, greater than or equal to 7,500 g/m²/24 hr, greater than or equal to 8,000 g/m²/24 hr, greater than or equal to 8,500 g/m²/24 hr, greater than or equal to 9,000 g/m²/24 hr, or greater than or equal to 9,500 g/m²/hr, greater than or equal to 10,000 g/m²/24 hr, greater than or equal to 10,500 g/m²/24 hr, greater than or equal to 11,000 g/m²/24 hr, greater than or equal to 11,500 g/m²/24 hr, or greater than or equal to 12,000 g/m²/24 hr, or greater than or equal to 12,500 g/m²/24 hr, or greater than or equal to 13,000 g/m²/24 hr. The MVTR when measured according to ASTM E96 BW “inverted cup” may be as high as 15,000 g/m²-24 hr, as high as 20,000 g/m²-24 hr, as high as 25,000 g/m²-24 hr, or as high as 30,000 g/m²-24 hr.

The material described in the preceding paragraph may comprise a stack of two or more biaxially stretched microporous films. The stack may, in some embodiments, comprise three or more biaxially stretched microporous films.

The biaxially stretched microporous films in the stack may have a thickness of from 5 to 50 microns or possibly from 10 to 20 microns.

In some embodiments, at least one or all of the two or more biaxially stretched microporous films in the stack are formed using a dry-stretch process. In some embodiments, at least one or all of the two or more biaxially stretched microporous films in the stack are formed using a beta-nucleation process. In some embodiments they may be formed by a wet process.

At least one of the two or more biaxially stretched microporous films in the stack may be monolayer, bilayer, trilayer, or multilayer microporous films. In some embodiments, all of the two or more biaxially stretched microporous films in the stack may be monolayer, bilayer, trilayer, or multilayer microporous films.

In some embodiments, at least one of the the two or more biaxially stretched microporous polymeric films comprises polypropylene (PP) homopolymer, PP copolymer, or a blend of PP with one or more other polymers. In some embodiments, all of the two or more biaxially stretched microporous polymeric films comprise polypropylene (PP) homopolymer, PP copolymer, or a blend of PP with one or more other polymers.

In some preferred embodiments, at least one or all of the two or more biaxially stretched microporous polymeric films comprises polypropylene (PP) copolymer. The polypropylene (PP) copolymer may comprise 3 to 20% polyethylene (PE).

Each film of the stack may be adjacent to at least one other film. Further, the films may be laminated to, bonded to, adhered to, ultrasonically welded to, or otherwise attached to one another in some embodiments. In some embodiments, they may not be attached to one another. For example, they may be held together with an electrostatic bond. In some embodiments, the microporous polymeric films of the stack may be attached along at least a portion of at least one edge.

In some embodiments, the material may comprise a woven or nonwoven attached to at least one surface of the stack of two or more biaxially stretched microporous films. In some embodiments, the material may comprise a woven or nowoven attached to both sides of the stack of two or more biaxially stretched microporous films.

In another aspect, another material or new material for personal protective equipment (PPE) that meets the requirements of Levels 1 to 3 or Levels 1 to 4 as such levels are described by the United States Centers for Disease Control (CDC) is disclosed. The material may comprise one or more The material may comprise one or more uniaxially stretched microporous polymeric films. In some preferred embodiments, at least one of the one or more uniaxially stretched microporous films may be formed using a dry-stretch process. At least one of the one or more uniaxially stretched microporous films may be a monolayer, bilayer, trilayer, or multilayer uniaxially stretched microporous film. The at least one uniaxially stretched microporous film may have slit-shaped pores. The thickness of the at least one uniaxially stretched microporous film may be from 5 to 100 microns, 5 to 50 microns, 5 to 40 microns, 5 to 30 microns, 5 to 25 microns, 5 to 20 microns, 5 to 15 microns, or 5 to 10 microns. Additionally, the material may have improved comfort or breathability compared to currently available personal protective equipment (PPE) material. For example, the material may have a moisture vapor transmission rate (MVTR) when measured according to ASTM E96 BW “inverted cup” that is greater than or equal to 1,000 g/m²/24 hr, greater than or equal to 5,000 g/m²/24 hr, greater than or equal to 5,500 g/m²/24 hr, greater than or equal to 6,000 g/m²/24 hr, greater than or equal to 6,500 g/m²/24 hr 7,000 g/m²/24 hr, greater than or equal to 7,500 g/m²/24 hr, greater than or equal to 8,000 g/m²/24 hr, greater than or equal to 8,500 g/m²/24 hr, greater than or equal to 9,000 g/m²/24 hr, or greater than or equal to 9,500 g/m²/hr, greater than or equal to 10,000 g/m²/24 hr, greater than or equal to 10,500 g/m²/24 hr, greater than or equal to 11,000 g/m²/24 hr, greater than or equal to 11,500 g/m²/24 hr, or greater than or equal to 12,000 g/m²/24 hr, or greater than or equal to 12,500 g/m²/24 hr, or greater than or equal to 13,000 g/m²/24 hr. The MVTR when measured according to ASTM E96 BW “inverted cup” may be as high as 20,000 g/m²-24 hr.

In some embodiments the at least one uniaxially stretched microporous film comprises a polypropylene homopolymer, polypropylene copolymer, or a blend of polypropylene and another polymer.

In some embodiments, a woven or nonwoven is attached to at least one side of the stack of one or more uniaxially stretched microporous polymeric films. In some embodiments, a woven or nonwoven is attached to both sides of the stack of one or more uniaxially stretched microporous polymeric films.

In another aspect, yet another material or new material for personal protective equipment (PPE) that meets the requirements of Levels 1 to 3 or Levels 1 to 4 as such levels are described by the United States Centers for Disease Control (CDC) is disclosed. The material may comprise a multilayer microporous film, wherein the average pore size of at least one layer of the multilayer microporous film is less than 0.1 microns or the entire pore distribution of at least one layer of the multilayer microporous film is less than 0.1 microns. In some embodiments, the at least one layer of the multilayer microporous film that has an average pore size of less than 0.1 microns or an entire pore distribution of less than 0.1 microns is an internal layer. In some embodiments, the multilayer microporous film may be at least one of a laminated multilayer microporous film, a co-extruded multilayer film, or combinations thereof.

In one possibly preferred embodiments, the multilayer microporous film may have the following structure, in the following order: a biaxially stretched microporous film; a porous film having an average pore size of less than 0.1 microns or an entire pore distribution of less than 0.1 microns; and a biaxially stretched microporous film. At least one of the biaxially stretched microporous films may be made by a dry-stretch process or by a beta-nucleation process. In some embodiments, at least one of the the biaxially stretched films is a monolayer film. In some embodiments, at least one of the biaxially stretched films may comprise a polypropylene homopolymer, a polypropylene copolymer, or polymer blend of polypropylene and at least one other polymer. In a possibly preferred embodiment, at least one of the biaxially stretched films comprises a polypropylene copolymer comprising 3 to 20% PE.

In another aspect, personal protective equipment (PPE) comprising any one of the materials for PPE described herein is described. The PPE may be any one of a mask, a hat, a surgical cap, gloves, a hospital gown, scrubs, a jacket, a surgical shoe cover, a hazmat suit, a blanket, a surgical drape, a laboratory coat, coveralls, a privacy curtain, a vest, an apron, a chemical protective suit, and a full body suit.

### DESCRIPTION OF THE FIGURES

FIG. 1 is an SEM of an exemplary biaxially stretched microporous film formed by a dry process.

FIG. 2 is an SEM of an exemplary biaxially stretched microporous film formed by a dry process.

FIG. 3 is an SEM of an exemplary biaxially stretched microporous film formed by a dry process.

FIG. 4 is an SEM of an exemplary biaxially stretched microporous film formed by a beta-nucleation process.

FIG. 5 is an SEM of an exemplary uniaxially stretched microporous film.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

Materials Comprising Biaxially-Stretched Microporous Film

Materials for personal protective equipment (PPE) that comprise, consist of, or consist essentially of one or more biaxially-stretched microporous films are described herein. A single biaxially-stretched microporous film may offer resistance to blood when tested according to ASTM F1670, water resistance, and breathability or comfort among other properties. In some preferred embodiments, the material for PPE may comprise two or more biaxially-stretched microporous films. These materials with two or more, three or more, four or more, five or more, six or more, seven or more, eight or more, nine or more, or 10 or more biaxially-stretched microporous films have been found to offer resistance to virus when tested according to ASTM F1671 in addition to the properties already offered by embodiments where a single biaxially-stretched microporous film is used. For example, materials comprising, consisting of, or consisting essentially of a stack of two or more biaxially-stretched microporous films have found to pass when tested at a certified laboratory according to ASTM F1671 modified @ 60 in-lb instead of the typical 120 in-lb. To pass this test, a result of zero plaque forming units is required.

Additionally, the material may have improved comfort or breathability compared to currently available personal protective equipment (PPE) material and compared to other embodiments described herein. For example, the material may have a moisture vapor transmission rate (MVTR) when measured according to ASTM E96 BW “inverted cup” that is greater than or equal to 1,000 g/m²/24 hr, greater than or equal to 5,000 g/m²/24 hr, greater than or equal to 5,500 g/m²/24 hr, greater than or equal to 6,000 g/m²/24 hr, greater than or equal to 6,500 g/m²/24 hr 7,000 g/m²/24 hr, greater than or equal to 7,500 g/m²/24 hr, greater than or equal to 8,000 g/m²/24 hr, greater than or equal to 8,500 g/m²/24 hr, greater than or equal to 9,000 g/m²/24 hr, or greater than or equal to 9,500 g/m²/hr, greater than or equal to 10,000 g/m²/24 hr, greater than or equal to 10,500 g/m²/24 hr, greater than or equal to 11,000 g/m²/24 hr, greater than or equal to 11,500 g/m²/24 hr, or greater than or equal to 12,000 g/m²/24 hr, or greater than or equal to 12,500 g/m²/24 hr, or greater than or equal to 13,000 g/m²/24 hr. The MVTR when measured according to ASTM E96 BW “inverted cup” may be as high as 15,000 g/m²-24 hr, as high as 20,000 g/m²-24 hr, as high as 25,000 g/m²-24 hr, or as high as 30,000 g/m²-24 hr.

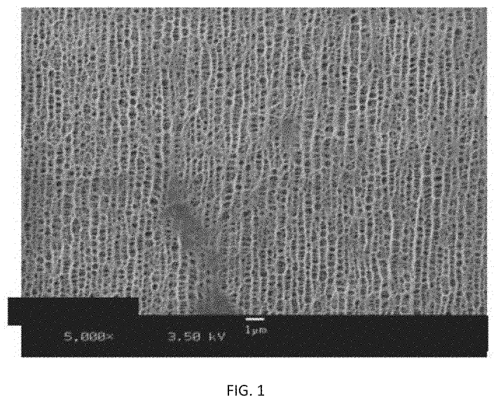

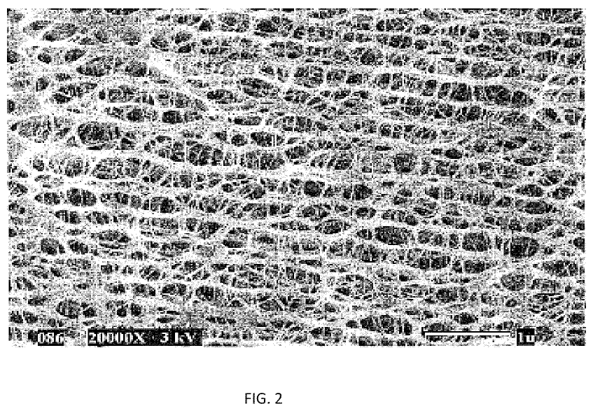

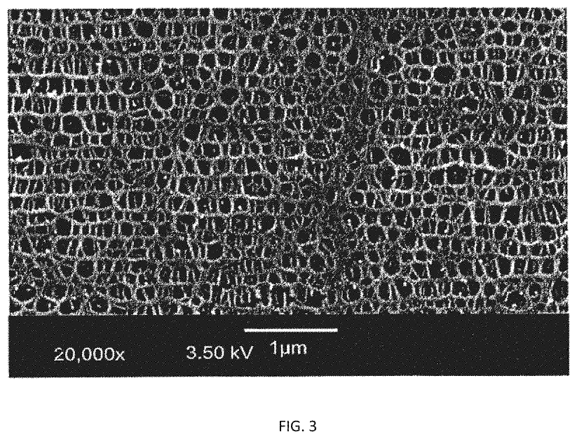

In some embodiments, the biaxially stretched films of the material may be biaxially stretched films formed using a dry-stretched process, including the Celgard® dry-stretched process. A typical dry-stretch process comprises extrusion of a polymer without the use of solvent or oils or with only minimal amounts of solvents or oils. The extruded film is then stretched in the machine direction (MD) to form pores. A biaxially stretched film is additionally stretched in another direction. For example, the film may also be stretched in the transverse direction (TD), which is perpendicular to the MD. Stretching in the TD may be from 1× to 10×, from 1× to 9×, from 1× to 8×, from 1× to 7×, from 1× to 6×, from 1× to 5×, from 1× to 4×, from 1× to 3×, or from 1× to 2×. Exemplary biaxially-stretched microporous films are disclosed in, for example, U.S. Pat. No. 8,795,565 (the '565 Patent) US Application No. 2017/0084898 (the '898 Application), and US Application No. 2017/0266865 (the '865 Application), which are both incorporated by reference herein in their entirety. Biaxially-stretched films that are formed by a dry-stretched process have round or substantially round-shaped pores, trapezoidal pores, rectangular-shaped pores, or the like. This is in comparison to the slit-shaped pores typical of a uniaxially-stretched microporous film formed by a dry-stretch process. Exemplary SEMS of biaxially-stretched microporous films made using a dry-stretched process are shown in FIG. 1, FIG. 2, and FIG. 3.

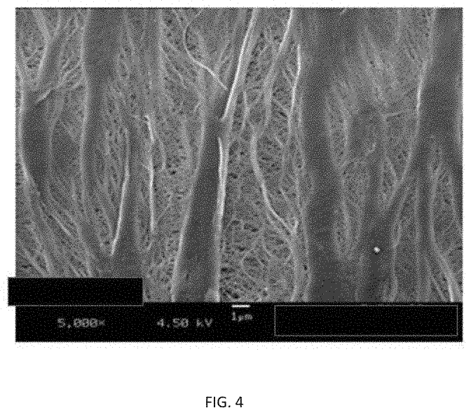

In some other embodiments, the biaxially stretched microporous film may be formed using a beta-nucleating process. Such processes may involve extrusion of a polymer using a beta nucleator or a beta nucleating agent. For example, the film may be a beta-nucleated, biaxially oriented polypropylene (BNBOPP) film also called a biaxially oriented polypropylene (BOPP) film. FIG. 4 herein shows the structure of an exemplary BNBOPP or BOPP film formed using a beta-nucleator or beta-nucleating agent. This process may include stretching in the MD and TD, where stretching in the TD may be from 1× to 10×, from 1× to 9×, from 1× to 8×, from 1× to 7×, from 1× to 6×, from 1× to 5×, from 1× to 4×, from 1× to 3×, or from 1× to 3×.

In certain embodiments, the product may be stretched in the MD and/or TD, and/or the process may include stretching in the MD and/or TD, and/or the TD stretching may include controlled MD relax.

In some embodiments, the material may need to be wide, and therefore the biaxially stretched films need to be wide. For example it may need to be at least 40 inches wide, at least 50 inches wide, at least 55 inches wide, at least 60 inches wide, at least 65 inches wide, or at least 70 inches wide.

Methods for making a wide film are not so limited and may include any one of the following or combinations thereof: 1) using a wide slot die; 2) use of a larger annular die; 3) increasing TD stretching; 4) seam two or more pieces together, which may include overlapping two edges or applying a seam tape over abutting edges among other methods; 5) open bubble by using any one or a combination of single spiral slit of bubble and lay flat before stretching, single straight slit and open before or after stretching, and other; 6) unfolding the bubble of a bubble extrusion process (one side slit of collapsed bubble, then unfold before or after stretching); 7) Combinations of 1-6; 8) slitting the collapsed bubble of a bubble extrusion process on one side, MD stretching it, then TD stretching it, then unfolding it; 9) do not slit the bubble—collapse the bubble, MD stretch it, then TD stretch it, then roll it into a wide un-slit roll form to be any one of slit on both sides, slit on one side and unfolded, or used as is.

In some embodiments, the average pore size of the biaxially stretched microporous film ranges from 0.05 to 1 microns, from 0.05 to 0.9 microns, from 0.05 to 0.8 microns, from 0.05 to 0.7 microns, from 0.05 to 0.6 microns, from 0.05 to 0.5 microns, from 0.05 to 0.4 microns, from 0.05 to 0.3 microns, from 0.05 to 0.2 microns, or from 0.05 to 0.1 microns. A range from 0.02 to 0.4, from 0.02 to 0.3, from 0.02 to 0.2 or 0.02 to 0.1 is possibly preferred in view of the fact that most viruses range in size from 20 to 400 namometers (0.02 to 0.4 microns).

In some possibly preferred embodiments, the biaxially stretched microporous film have a pore size distribution such that 100% of the pores have a diameter of 1 micron or less, 0.9 microns or less, 0.8 microns or less, 0.7 microns or less, 0.6 microns or less, 0.5 microns or less, 0.4 microns or less, 0.3 microns or less, 0.2 microns or less, 0.1 microns or less, 0.05 microns or less, or 0.02 microns or less. In some embodiments 95% or 90% of the pores have a diameter of 1 micron or less, 0.9 microns or less, 0.8 microns or less, 0.7 microns or less, 0.6 microns or less, 0.5 microns or less, 0.4 microns or less, 0.3 microns or less, 0.2 microns or less, 0.1 microns or less, 0.05 microns or less, or 0.02 microns or less. Biaxially stretched microporous films typically have bigger and different shaped pores than films that have only been uniaxially stretched.

One or more of the biaxially stretched microporous films in the stack may have a thickness of 5 to 50 microns, 10 to 50 microns, 15 to 50 microns, 20 to 50 microns, 25 to 50 microns, 30 to 50 microns, 35 to 50 microns, 40 to 50 microns, or 45 to 50 microns. The films may also, in some embodiments, be thicker than 50 microns, thicker than 100 microns, thicker than 150 microns, thicker than 200 microns, or up to 400 microns thick. Thicker films may be better able to resist viruses, but may be less breathable or provide less comfort.

In some embodiments, the gurley of one or more of the biaxially stretched microporous films in the stack may be less than 50 s, less than 45 s, less than 40 s, less than 35 s, less than 30 s, less than 25 s, less than 20 s, less than 15 s, or less than 10 s. In some preferred embodiments, the gurley may be less than 30 s, less than 25 s, less than 20 s, less than 15 s, or less than 10 s. Lower gurley of the films may contribute to the comfort and breathability of the resulting material.

Some or all films of the stack may comprise, consist of, or consist essentially of polypropylene homopolymer, polypropylene copolymer, or a blend of polypropylene and at least one other polymer. However, the material is not so limited and most any thermoplastic polymer will work.

In a preferred embodiment, some or all of the films of the stack may comprise, consist of, or consist essentially of a copolymer of polypropylene (PP) that comprises from 1 to 20%, from 2 to 20%, from 3 to 20%, from 4 to 20%, from 5 to 20%, from 6 to 20%, from 7 to 20%, from 8 to 20%, from 9 to 20%, from 10 to 20%, from 11 to 20% from 12 to 20%, from 13 to 20%, from 14 to 20%, from 15 to 20%, from 16 to 20%, from 17 to 20%, from 18 to 20%, or from 19 to 20% of polyethylene (PE). Preferably, the amount of PE is from 3 to 20% PE or from 3 to 10% PE. Use of the aforementioned PP-PE copolymer may result in a film, stack, and/or material having improved hand.

The biaxially stretched film may be a monolayer, bilayer, trilayer, or multilayer film. The bilayer, trilayer, and multilayer films may be coextruded bilayer, trilayer or multilayer films where two layers, three layers, or three or more layers are coextruded together. They can also be laminated bilayer, trilayer, or multilayer films, where two monolayers, three monolayers, or four or more monolayers are laminated together. In some embodiments, the trilayer or multilayer films may be formed using a combination of coextrusion and lamination. For example, a coextruded bilayer may be laminated to a monolayer to form a trilayer film, two coextruded bilayers may be laminated together to form a four layer multilayer film, three coextruded trilayers may be laminated together to form a nine layer multilayer film, etc.

In some preferred embodiments, the layers of the one, two, three, four, five, six, seven, eight, nine, or ten or more layer stack of biaxially stretched microporous films may be stacked on top of each other with no intervening films or layers. Each film of the stack may be directly adjacent to at least one other layer without any other intervening films or layers. In some embodiments, each film of the stack may be directly adjacent to at least one other layer without any other intervening films or layers except maybe an adhesive layer. In some embodiments, there may be intervening layers other than adhesives.

Some or all of the films of the stack may be attached or not attached to at least one other film. In preferred embodiments, some or all of the films of the stack are attached to at least one other film. The films may be attached by any means including, but not limited to, using an adhesive, lamination using heat, pressure, or heat and pressure, ultrasonic welding, bonding, and the like.

In some embodiments, the stack may have at least one of a woven material and a nonwoven material attached to at least one side thereof. In some embodiments, at least one of a woven material and a nonwoven material may be attached to both sides of the stack. The material on either side of the stack may be the same or different.

Materials Comprising Uniaxially Microporous Film

Materials for personal protective equipment (PPE) that comprise, consist of, or consist essentially of one uniaxially stretched microporous film or a stack of two or more, three or more, four or more, five or more, six or more, seven or more, eight or more, nine or more, or ten or more uniaxially-stretched microporous films are described herein. A single uniaxially-stretched microporous film may offer resistance to blood when tested according to ASTM F1670, water resistance, and resistance to virus when tested according to ASTM F1671 modified @ 60 in-lb instead of the typical 120 in-lb. Some uniaxially-stretched films may offer only resistance to blood when tested according to ASTM F1670, water resistance, and not to virus when tested according to ASTM F1671 modified @ 60 in-lb instead of the typical 120 in-lb. Without wishing to be bound by any particular theory, it is believed that uniaxially-stretched films that offer blood resistance, but not virus resistance, may have been stretched more than uniaxially-stretched films that offer both blood and virus resistance, resulting in pores that allow the virus to pass. Alternatively, if a different polymer may be used, e.g., polyethylene, larger pores may result from similar stretching conditions that would not result in another polymer, e.g., polypropylene.

However, materials made with uniaxially stretched microporous films may not be as breathable or comfortable as those made using biaxially stretched microporous films. However, they are found to be more breathable than personal protective equipment (PPE) currently available on the market. For example, the material may have a moisture vapor transmission rate (MVTR) when measured according to ASTM E96 BW “inverted cup” that is greater than or equal to 1,000 g/m²/24 hr, greater than or equal to 5,000 g/m²/24 hr, greater than or equal to 5,500 g/m²/24 hr, greater than or equal to 6,000 g/m²/24 hr, greater than or equal to 6,500 g/m²/24 hr 7,000 g/m²/24 hr, greater than or equal to 7,500 g/m²/24 hr, greater than or equal to 8,000 g/m²/24 hr, greater than or equal to 8,500 g/m²/24 hr, greater than or equal to 9,000 g/m²/24 hr, or greater than or equal to 9,500 g/m²/hr, greater than or equal to 10,000 g/m²/24 hr, greater than or equal to 10,500 g/m²/24 hr, greater than or equal to 11,000 g/m²/24 hr, greater than or equal to 11,500 g/m²/24 hr, or greater than or equal to 12,000 g/m²/24 hr, or greater than or equal to 12,500 g/m²/24 hr, or greater than or equal to 13,000 g/m²/24 hr. The MVTR when measured according to ASTM E96 BW “inverted cup” may be as high as 15,000 g/m²-24 hr, as high as 20,000 g/m²-24 hr, as high as 25,000 g/m²-24 hr, or as high as 30,000 g/m²-24 hr.

In some embodiments, the uniaxially stretched films of the material may be uniaxially stretched films formed using a dry-stretched process, including the Celgard® dry-stretched process. A typical dry-stretch process comprises extrusion of a polymer without the use of solvent or oils or with only minimal amounts of solvents or oils. The extruded film is then stretched in the machine direction (MD) to form pores. In some embodiments, the uniaxially stretched films may be formed using a wet process.

In some embodiments, the material may need to be wide, and therefore the uniaxially stretched films need to be wide. For example it may need to be at least 40 inches wide, at least 50 inches wide, at least 55 inches wide, at least 60 inches wide, at least 65 inches wide, or at least 70 inches wide.

Methods for making a wide film are not so limited and may include any one of the following or combinations thereof: 1) using a wide slot die; 2) use of a larger annular die; 3) seam two or more pieces together, which may include overlapping two edges or applying a seam tape over abutting edges among other methods; 4) open bubble by using any one or a combination of single spiral slit of bubble and lay flat before stretching, single straight slit and open before or after stretching, and other; 5) unfolding the bubble of a bubble extrusion process (one side slit of collapsed bubble, then unfold before or after stretching); 6) Combinations of 1-5.

In some embodiments, the average pore size of the uniaxially stretched microporous film ranges from 0.05 to 1 microns, from 0.05 to 0.9 microns, from 0.05 to 0.8 microns, from 0.05 to 0.7 microns, from 0.05 to 0.6 microns, from 0.05 to 0.5 microns, from 0.05 to 0.4 microns, from 0.05 to 0.3 microns, from 0.05 to 0.2 microns, or from 0.05 to 0.1 microns. A range from 0.02 to 0.4, from 0.02 to 0.3, from 0.02 to 0.2 or 0.02 to 0.1 is possibly preferred in view of the fact that most viruses range in size from 20 to 400 namometers (0.02 to 0.4 microns).

In some possibly preferred embodiments, the uniaxially stretched microporous films have a pore size distribution such that 100% of the pores have a diameter of 1 micron or less, 0.9 microns or less, 0.8 microns or less, 0.7 microns or less, 0.6 microns or less, 0.5 microns or less, 0.4 microns or less, 0.3 microns or less, 0.2 microns or less, 0.1 microns or less, 0.05 microns or less, or 0.02 microns or less. In some embodiments 95% or 90% of the pores have a diameter of 1 micron or less, 0.9 microns or less, 0.8 microns or less, 0.7 microns or less, 0.6 microns or less, 0.5 microns or less, 0.4 microns or less, 0.3 microns or less, 0.2 microns or less, 0.1 microns or less, 0.05 microns or less, or 0.02 microns or less.

One or more of the uniaxially stretched microporous films may have a thickness of 5 to 50 microns, 10 to 50 microns, 15 to 50 microns, 20 to 50 microns, 25 to 50 microns, 30 to 50 microns, 35 to 50 microns, 40 to 50 microns, or 45 to 50 microns. The films may also, in some embodiments, be thicker than 50 microns, thicker than 100 microns, thicker than 150 microns, thicker than 200 microns, or up to 400 microns thick. Thicker films may be better able to resist viruses.

Some or all films may comprise, consist of, or consist essentially of polypropylene homopolymer, polypropylene copolymer, or a blend of polypropylene and at least one other polymer. However, the material is not so limited and most any thermoplastic polymer will work.

In a preferred embodiment, some or all of the films may comprise, consist of, or consist essentially of a copolymer of polypropylene (PP) that comprises from 1 to 20%, from 2 to 20%, from 3 to 20%, from 4 to 20%, from 5 to 20%, from 6 to 20%, from 7 to 20%, from 8 to 20%, from 9 to 20%, from 10 to 20%, from 11 to 20% from 12 to 20%, from 13 to 20%, from 14 to 20%, from 15 to 20%, from 16 to 20%, from 17 to 20%, from 18 to 20%, or from 19 to 20% of polyethylene (PE). Preferably, the amount of PE is from 3 to 20% PE or from 3 to 10% PE. Use of the aforementioned PP-PE copolymer may result in a film, stack, and/or material having improved hand.

The uniaxially stretched film may be a monolayer, bilayer, trilayer, or multilayer film. The bilayer, trilayer, and multilayer films may be coextruded bilayer, trilayer or multilayer films where two layers, three layers, or three or more layers are coextruded together. They can also be laminated bilayer, trilayer, or multilayer films, where two monolayers, three monolayers, or four or more monolayers are laminated together. In some embodiments, the trilayer or multilayer films may be formed using a combination of coextrusion and lamination. For example, a coextruded bilayer may be laminated to a monolayer to form a trilayer film, two coextruded bilayers may be laminated together to form a four layer multilayer film, three coextruded trilayers may be laminated together to form a nine layer multilayer film, etc.

In some preferred embodiments, a single uniaxially stretched microporous film may be used to form the material. However, a stack of uniaxially stretched microporous films may also be used. In a stack, the two, three, four, five, six, seven, eight, nine, or ten or more layer stack of uniaxially stretched microporous films may be stacked on top of each other with no intervening films or layers. Each film of the stack may be directly adjacent to at least one other layer without any other intervening films or layers. In some embodiments, each film of the stack may be directly adjacent to at least one other layer without any other intervening films or layers except maybe an adhesive layer. In some embodiments, there may be intervening layers other than adhesives.

Some or all of the films of the stack may be attached or not attached to at least one other film. In preferred embodiments, some or all of the films of the stack are attached to at least one other film. The films may be attached by any means including, but not limited to, using an adhesive, lamination using heat, pressure, or heat and pressure, ultrasonic welding, bonding, and the like.

In some embodiments, one or more uniaxially stretched films may be attached to one or more biaxially stretched films.

In some embodiments, the single uniaxially stretched microporous film or the stack of uniaxially stretched microporous films may have at least one of a woven material and a nonwoven material attached to at least one side thereof. In some embodiments, at least one of a woven material and a nonwoven material may be attached to both sides of the stack. The material on either side of the stack may be the same or different.

Multilayer Microporous Film Material

A material that may have at least one of water resistance, resistance to blood penetration when tested according to ASTM F1670 and viral penetration resistance when tested according to ASTM F1671 is disclosed herein. In some embodiments, this material may also exhibit good hand or feel.

The material may comprise, consist of, or consist essentially of a multilayer microporous film. The multilayer microporous film includes at least one layer that has at least one of the following properties: an average pore size less than or equal to about 0.2, 0.15, or 0.1 microns and an entire pore distribution less than or equal to about 0.2, 0.15, or 0.1 microns. It is preferred that at least one layer has an average pore size less than about 0.1 microns and an entire pore distribution less than about 0.1 microns. Having an entire pore distribution less than 0.1 microns means that 100% of the pores in that layer have a size of 0.1 microns or less.

The multilayer microporous film may have two, three, four, five, six, seven, eight, nine, ten or more layers. The multilayer microporous film may be formed by coextrusion, lamination, or a combination of coextrusion and lamination. For example, a two layer film may be formed by coextruding two layers or laminating two monolayers together. A nine layer film may be formed by coextruding three trilayers and laminating them together.

In some embodiments, the at least one layer having an average pore size less than or equal to about 0.2, 0.15, or 0.1 microns and/or an entire pore distribution less than or equal to about 0.2, 0.15, or 0.1 microns is an internal layer.

In a possibly preferred embodiment, the multilayer microporous film may have the following layers in the following order: a biaxially stretched microporous film layer; a porous film layer having an average pore size of less than 0.1 microns an/or an entire pore distribution of less than 0.1 microns; and a biaxially stretched microporous film layer. In this embodiment, at least one of the biaxially stretched microporous films may be made by a dry-stretch process. In some embodiments, both are. As an alternative, at least one of the biaxially-stretched microporous films may be made using a beta-nucleation process.

In some preferred embodiments, the biaxially stretched films is a monolayer film, but it may also be a bilayer, trilayer, or multilayer film.

The material of the biaxially stretched films is not so limited. Any thermoplastic polymer capable of being extruded may be used. In some preferred embodiments, the biaxially stretched films may comprise, consist of, or consist essentially of a polypropylene homopolymer, a polypropylene copolymer, or polymer blend of polypropylene and at least one other polymer.

In a preferred embodiment, the biaxially stretched films may comprise, consist of, or consist essentially of a polypropylene (PP) copolymer that comprises from 1 to 20%, from 2 to 20%, from 3 to 20%, from 4 to 20%, from 5 to 20%, from 6 to 20%, from 7 to 20%, from 8 to 20%, from 9 to 20%, from 10 to 20%, from 11 to 20% from 12 to 20%, from 13 to 20%, from 14 to 20%, from 15 to 20%, from 16 to 20%, from 17 to 20%, from 18 to 20%, or from 19 to 20% of polyethylene (PE). Preferably, the amount of PE is from 3 to 20% PE or from 3 to 10% PE. Use of the aforementioned PP-PE copolymer may result in a material having improved hand. This is particularly true if both biaxially stretched films consist of the copolymer.

In some embodiments, at least one of a woven and a nonwoven may be attached to one or both sides of the multilayer microporous film. In some embodiments, a woven may be attached to one side and a nonwoven attached to the other side of the multilayer microporous film.

Personal Protective Equipment

Personal protective equipment (PPE) made from any of the materials described herein is described. The PPE is not so limited and may be at least one of reusable, disposable, and recyclable. In some embodiments, the PPE may be made of a polypropylene material and the seams of the PPE may be sealed using a polypropylene seam tape. Such a garment would be recyclable.

In some preferred embodiments, the PPE may be made of the material comprising two or more biaxially-streched microporous films. This PPE is more breathable or comfortable.

Examples of personal equipment that may be formed using the materials disclosed herein include, but are not limited to a mask, a hat, a surgical cap, gloves, a hospital gown, scrubs, a jacket, a surgical shoe cover, a hazmat suit, a blanket, a surgical drape, a laboratory coat, coveralls, a privacy curtain, a vest, an apron, a chemical protective suit, and a full body suit.

Other exemplary uses of the materials disclosed herein include any use where protection from blood, viruses, or both may be desired. Examples of alternative or desired personal protective equipment (PPE) or like items include without limitation the following: gowns, hoods, booties, drapes, masks, gloves, capes, etc.

Other exemplary uses of the materials disclosed herein include any use where protection from water, blood, liquid, viruses, or combinations thereof may be desired. Examples of such alternative or desired textiles, fabrics, laminates, personal protective equipment, garments, or like items include without limitation the following: a shower curtain; a car seat; automotive seat fabric; a booster seat; an automotive fabric; an automotive seat cover, headliner, speaker cover, filter, or door panel material; upholstery or furniture fabric; outdoor furniture fabric; material for an outdoor furniture cover; a pillow; baby gear including pack-and-plays, bassinettes, portable cribs, or co-sleepers; a car, vehicle, or bike cover; an umbrella; an awning; a tent; a shift tent, e.g., for virus testing; a tarp; decorative wall fabric; decorative cubicle fabric; wall coverings; floor coverings; window coverings; rugs; HVAC filters; air filters; filters; medical products, Level 1-3 products; Level 1-4 products; Level 3 products; Level 4 products; at least 40 inch wide products; at least 50 inch wide products; at least 60 inch wide products; creped products; micro-creped products; laminates of fabric and membrane; laminates of fabric, adhesive, and membrane; laminates of at least one fabric layer and at least one membrane layer; coated laminates; laminates coated on one side; laminates coated on both sides; Level 1-3 laminates; Level 1-4 laminates; Level 3 laminates; Level 4 laminates; and/or combinations thereof.

### EXAMPLES

Initial tests were conducted with Comparative Example 1, which is an 18-20 micron biaxially stretched PP monolayer, Comparative Example 2, which is a 16 micron biaxially stretched PP monolayer, and Comparative Example 3, which is a 12 micron biaxially stretched PP monolayer. The biaxially stretched PP monolayers of Comparative Examples 1, 2, and 3 failed ASTM F1671.

Inventive Example 1 was created by stacking (with no intervening layers) two of the biaxially stretched PP monolayers of Comparative Example 1 directly on top of one another. Inventive Example 2 was created by stacking (with no intervening layers) three of the biaxially stretched PP monolayers of Comparative Example 1 directly on top of one another. These Examples were also tested and passed ASTM F1671. This was a surprising result.

Inventive Example 3 was created by stacking (with no intervening layers) two of the biaxially stretched PP monolayers of Comparative Example 2 directly on top of one another. Inventive Example 4 was created by stacking (with no intervening layers) three of the biaxially stretched PP monolayers of Comparative Example 2 directly on top of one another. These Examples have not yet been tested according to ASTM F1671, but Applicant presumes both would pass.

Inventive Example 10 was created by stacking (with no intervening layers) two of the biaxially stretched PP monolayers of Comparative Example 3 directly on top of one another. Inventive Example 10 was tested according to ASTM F1671 and passed. This was a surprising result.

Example 5 was formed by attaching a nonwoven to either side of the film of Comparative Example 1.

Example 6 was formed by attaching a nonwoven to one side of the film of Comparative Example 1.

Inventive Example 7 was formed by laminating a layer having an average pore size less than or equal to 0.1 and having an entire pore distribution less than or equal to 0.1 (100% of pores have a size less than or equal to 0.1 microns) with two biaxially-stretched microporous films. The two biaxially-stretched microporous films were laminated on either side of the layer having an average pore size less than or equal to 0.1 and having an entire pore distribution less than or equal to 0.1. The biaxially-stretched microporous films were made entirely of a polypropylene copolymer having a PE contend from 3 to 20%. This resulted in improved hand feel of Inventive Example 5. The layer having an average pore size less than or equal to 0.1 and having an entire pore distribution less than or equal to 0.1 acted as a virus blocking layer.

Inventive Example 8 was like Example 7 except the layers were coextruded.

Inventive Example 9 is a 12 micron uniaxially stretched PP monolayer product

All samples were tested using a modified version of ASTM F1671 @ 60 in-lb instead of the typical 120 in-lb.

All testing was done in a certified laboratory.

To “pass” ASTM F1671, a result of 0 or about 0 plaque forming units (PFUs) per milliliter of test cell wash (PFU/mL) is required.

Results are shown in the Table below:

TABLE 1

| | | | | | Moisture Vapor |
|---|---|---|---|---|---|
| | | Resistance | | | Transmission Rate |
| | | to Blood | Test Cell | | (MVTR) according |
| | | ASTM | Wash | | to ASTM E96 BW |
| Example | Gurley (s) | F1670 | (PFU/mL) | Result | (g/m²-24 hr) |
| Inventive Example 1 | Not | yes | 0 | Pass | 10,074 |
| (2 biaxially stretched | measured yet | | | | |
| PP monolayers) | | | | | |
| Inventive Example 2 | Not | yes | 0 | Pass | Not |
| (3 biaxially stretched | measured yet | | | | measured |
| PP monolayers) | | | | | |
| Inventive Example 3 | 90 | yes | not | not | Not |
| (2 biaxially stretched | | | measured | measured | measured |
| PP monolayers) | | | | | |
| Inventive Example 4 | 135 | yes | not | not | not |
| (3 biaxially stretched | | | measured | measured | measured |
| PP monolayers) | | | | | |
| Inventive Example 5 | Not | Yes | 0 | Pass | Not |
| (Nonwoven +1 biaxially | measured yet | | | | measured |
| stretched PP monolayer + | | | | | |
| Nonwoven) | | | | | |
| Inventive Example 6 | Not | Yes | 0 | Pass | Not |
| (nonwoven +1 biaxially | measured yet | | | | measured |
| stretched PP monolayer) | | | | | |
| Inventive Example 9 | 115 | Yes | 0 | Pass | 10,483 |
| (1 uniaxially stretched | | | | | |
| PP monolayer) | | | | | |
| Inventive Example 10 | | yes | 0 | Pass | 9,222 |
| (2 biaxially stretched | | | | | |
| PP monolayers) | | | | | |
| Inventive Example 11 | <115 | Yes | | predicted | <10,483 |
| (1 uniaxially stretched | predicted | (predicted) | | to Fail | predicted |
| PP monolayer) | | | | | |
| Inventive Example 12 | <115 | Yes | | predicted | <10,483 |
| (1 uniaxially stretched | predicted | (predicted) | | to fail | predicted |
| PE monolayer) | | | | | |
| Comparative Example 1 | about 20 | Yes | 32 | Fail | 11,639 |
| (1 biaxially stretched | | | | | |
| PP monolayer) | | | | | |
| Comparative Example 2 | 45 | Yes | >200 | Fail | Not |
| (1 biaxially stretched | | | | | measured |
| PP monolayer) | | | | | |
| Comparative Example 3 | | yes | 20 | Fail | 13,725 |
| (1 biaxially stretched | | | | | |
| PP monolayer) | | | | | |

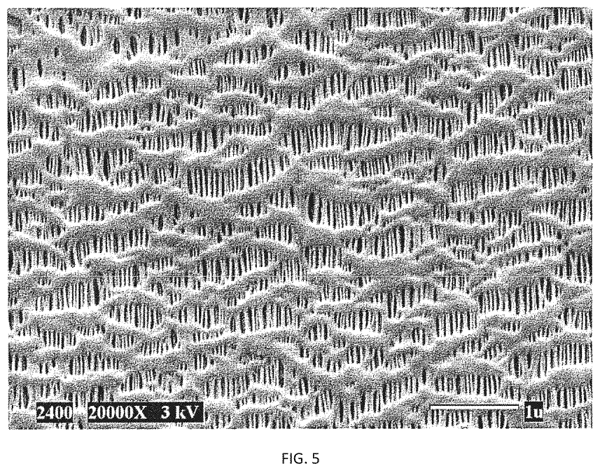

The results show that a monolayer uniaxially stretched (MD stretched only) product passed the test. Without wishing to be bound by any particular theory, it is believed that the pore size, the slit-shape of the pores, or a combination thereof of the uniaxially stretched product enable it to resist the virus penetration. Even if the slit length is longer than the virus size the narrow width of the slit will block viral penetration. Pore size, particularly width, of the monolayer uniaxially stretched product of Example 9 range from 0.03 to 0.09 microns. An SEM of a typical monolayer dry-stretch product that has been uniaxially stretched is shown in FIG. 5. Inventive Example 9 also has excellent MVTR. Inventive Example 9 may have advantages over the other Inventive Examples because only a single film (not a stack) is needed to provide virus resistance and similar breathability. This is true despite the fact that a single layer of the individual monolayer membranes used to form the stacks in the other Inventive Examples have better MVTR on their own (not stacked) than the membrane in Inventive Example 9.

Pore size of the biaxially stretched monolayers (Comparative Examples 1, 2, and 3) are larger than those of a uniaxially stretched monolayer. An SEM of a typical monolayer dry-stretch product that has been biaxially stretched is shown in FIG. 2. For example, Comparative Example 1 may have pore sizes as large as 0.2 microns, allowing viruses to get through and resulting in failure of ASTM F1671. However, Applicant has also found that stacks of as few as two or three biaxially stretched films can unexpectedly pass ASTM F1671. This is shown by comparing the results of Inventive Examples 1 and 2 with those of Comparative Example 1 and comparing the results of Inventive Example 10 with those of Comparative Example 3. Further still, Applicant has found that bonding a biaxially stretched monolayer PP with a single nonwoven (Inventive Example 6) or a nonwoven on each side (Inventive Example 5) also results in a film that unexpectedly passes ASTM F1671.

In accordance with at least certain embodiments, aspects, or objects, the present disclosure or invention is directed to and/or provides products or components as described, claimed or shown herein.

In accordance with at least selected embodiments, aspects, or objects, the present disclosure or invention is directed to and/or provides products, components, or uses of the materials disclosed herein including without limitation use where protection from blood, viruses, or both may be desired. For example, alternative or desired personal protective equipment (PPE) or like items include without limitation the following: gowns, hoods, booties, drapes, masks, gloves, capes, etc.

In accordance with at least selected embodiments, aspects, or objects, the present disclosure or invention is directed to and/or provides products, components, or uses of the materials disclosed herein including without limitation use where protection from water, blood, liquid, viruses, or combinations thereof may be desired. For example, alternative or desired textiles, fabrics, laminates, personal protective equipment, garments, or like items include without limitation the following: a shower curtain; a car seat; automotive seat fabric; a booster seat; an automotive fabric; an automotive seat cover, headliner, speaker cover, filter, or door panel material; upholstery or furniture fabric; outdoor furniture fabric; material for an outdoor furniture cover; a pillow; baby gear including pack-and-plays, bassinettes, portable cribs, or co-sleepers; a car, vehicle, or bike cover; an umbrella; an awning; a tent; e.g., a shift tent for a virus testing station; a tarp; decorative wall fabric; decorative cubicle fabric; wall coverings; floor coverings; window coverings; rugs; HVAC filters; air filters; filters; medical products, Level 1-3 products; Level 1-4 products; Level 3 products; Level 4 products; at least 40 inch wide products; at least 50 inch wide products; at least 60 inch wide products; creped products; micro-creped products; laminates of fabric and membrane; laminates of fabric, adhesive, and membrane; laminates of at least one fabric layer and at least one membrane layer; coated laminates; laminates coated on one side; laminates coated on both sides; Level 1-3 laminates; Level 1-4 laminates; Level 3 laminates; Level 4 laminates; and/or combinations thereof.

1. A material for personal protective equipment (PPE) that is resistant to at least one of blood and viruses, the material comprising a stack of two or more biaxially stretched microporous polymeric films; wherein optionally one or more of the following:
a woven or nonwoven layer is attached to one or both sides of the stack, and/or
at least one of the two or more biaxially stretched microporous polymeric films are formed using a dry-stretch process or a beta-nucleation process, and/or
a JIS Gurley of one or more of the biaxially stretched microporous polymeric films is less than 50 s, less than 40 s, less than 30 s, less than 20 s, or less than 10 s, and/or
at least one of the two or more biaxially stretched microporous polymeric films is a monolayer biaxially stretched polymeric film, and/or
at least one of the two or more biaxially stretched microporous polymeric films is a bilayer, trilayer, or multilayer biaxially stretched polymeric film.

2. (canceled)

3. (canceled)

4. (canceled)

5. (canceled)

6. (canceled)

7. (canceled

8. (canceled)

9. The material of claim 1, wherein at least one of the two or more biaxially stretched microporous polymeric films comprises polypropylene (PP) homopolymer, PP copolymer, or a blend of PP with one or more other polymers.

10. (canceled)

11. The material of claim 9, wherein at least one of the two or more biaxially stretched microporous polymeric films comprises polypropylene (PP) copolymer and optionally wherein the polypropylene (PP) copolymer comprises 3 to 20% polyethylene (PE).

12. (canceled)

13. (canceled)

14. The material of claim 1, wherein each biaxially stretched microporous polymeric film is adjacent to at least one other biaxially stretched microporous polymeric film, wherein one or more of the following:
the films are laminated to, chemically, electrostatically, or physically bonded to, adhered to, ultrasonically welded to, or otherwise attached to one another, and/or
the biaxially stretched microporous polymeric films of the stack are bonded together along at least one edge, and/or
wherein the biaxially stretched microporous polymeric films of the stack are attached to one another using ultrasonic welding or a similar process.

15. (canceled)

16. (canceled)

17. The material of claim 1, wherein at least one of the two or more biaxially stretched microporous polymeric films has a thickness from 5 to 50 microns or from 10 to 20 microns.

18. (canceled)

19. The material of claim 1, wherein the material passes ASTM F1671 Procedure B, Using Nylon Mesh Retaining Screen at 60 in-lb or 120 in-lb and/or when tested using ASTM F1671, gives a result of 10 or less plaque forming units (PFUs) or 5 PFUs or 0 PFUs.

20. (canceled)

21. (canceled)

22. (canceled)

23. (canceled)

24. (canceled)

25. The material of claim 1, having an MVTR greater than about 5,000 g/m²-24 h, greater than about 6,000 g/m²-24 h, greater than about 7,000 g/m2-24 h, greater than about 8,000 g/m²-24 h, greater than about 9,000 g/m²-24 h, greater than about 10,000 g/m2-24 h or as high as 15,000g/m²-24 hr, as high as 20,000 g/m²-24 h when measured according to ASTM E96 BW.

26. (canceled)

27. Personal protective Equipment (PPE) comprising the material of claim 1.

28. The personal protective equipment (PPE) of claim 27, wherein the PPE is any one of a mask, a hat, a surgical cap, gloves, a hospital gown, scrubs, a jacket, a surgical shoe cover, a hazmat suit, a blanket, a surgical drape, a laboratory coat, a uniform, coveralls, a privacy curtain, a vest, an apron, a chemical protective suit, and a full body suit, and optionally wherein the PPE is reusable or disposable.

29. (canceled)

30. A material for personal protective equipment (PPE) that is resistant to at least one of blood and viruses, the material comprising one uniaxially stretched microporous polymeric film or a stack of two or more uniaxially stretched microporous polymeric films, and wherein one or more of the following:
wherein at least one of the two or more biaxially stretched microporous polymeric films are formed using a dry-stretch process or wherein at least one of the two or more biaxially stretched microporous polymeric films are formed using a beta-nucleation process and/or
wherein at least one of a woven, a nonwoven, and a biaxially stretched microporous film is attached to one or both sides of the one uniaxially stretched microporous membrane or the stack of two or more uniaxially stretched microporous membranes.

31. The material of claim 30, wherein at least one of the following:
the uniaxially stretched microporous films comprise polypropylene homopolymer, polypropylene copolymer, or a blend of polypropylene and another polymer and/or
a thickness of the one uniaxially stretched microporous polymeric film or the stack of two or more uniaxially stretched microporous polymeric films is from 5 to 40 microns, and/or
wherein a thickness of the one uniaxially stretched microporous polymeric film or the stack of two or more uniaxially stretched microporous polymeric films is from 10 to 30 microns and/or
having an MVTR greater than about 5,000 g/m²-24 h, greater than about 6,000 g/m²-24 h, greater than about 7,000 g/m²-24 h, greater than about 8,000 g/m²-24 h, greater than about 9,000 g/m²-24 h, greater than about 10,000 g/m²-24 h or as high as 15,000 g/m² or as high as 20,000 g/m²-24 h when measured according to ASTM E96 BW.

32. (canceled)

33. (canceled)

34. (canceled)

35. (canceled)

36. (canceled)

37. Personal Protective Equipment (PPE) comprising the material of claim 30.

38. The personal protective equipment (PPE) of claim 37, wherein the PPE is any one of a mask, a hat, a surgical cap, gloves, a hospital gown, scrubs, a jacket, a surgical shoe cover, a hazmat suit, a blanket, a surgical drape, a laboratory coat, a uniform, coveralls, a privacy curtain, a vest, an apron, a chemical protective suit, and a full body suit and optionally wherein the PPE is disposable or reusable.

39. (canceled)

40. A material for personal protective equipment that is resistant to at least one of blood and viruses, the material comprising:
a biaxially stretched microporous film;
a woven or nonwoven attached to at least one side of the biaxially stretched microporous film; and optionally one or more of the following:
the biaxially stretched microporous film is made by a dry-stretch process or the biaxially stretched microporous film is formed using a beta-nucleation process, and/or
a woven or a nonwoven is attached to both sides of the biaxially stretched microporous film, and/or
wherein the microporous film comprises polypropylene homopolymer, polypropylene copolymer, or a blend of polypropylene and another polymer, and/or
the material passes ASTM F1671 @ 60 in-lb.

41. (canceled)

42. (canceled)

43. (canceled)

44. (canceled)

45. (canceled)

46. A personal protective equipment (PPE) comprising the material of any one of claim 40.

47. The PPE of claim 46, wherein the PPE is any one of a mask, a hat, a surgical cap, gloves, a hospital gown, scrubs, a jacket, a surgical shoe cover, a hazmat suit, a blanket, a surgical drape, a laboratory coat, a uniform, coveralls, a privacy curtain, a vest, an apron, a chemical protective suit, and a full body suit.

48. A material for personal protective equipment that is resistant to at least one of blood and viruses, the material comprising a multilayer microporous film wherein the average pore size of at least one layer of the multilayer microporous film is less than or equal to 0.2 microns, less than or equal to 0.15 microns, or less than or equal to 0.1 microns and/or the entire pore distribution of at least one layer of the multilayer microporous film is less than or equal to 0.2 microns, less than or equal to 0.15 microns, or less than or equal to 0.1 microns and optionally wherein the at least one layer is an internal layer.

49. (canceled)

50. (canceled)

51. (canceled)

52. The material of claim 48, wherein the multilayer microporous film is at least one of a laminated multilayer microporous film, a co-extruded multilayer film, or combinations thereof.

53. The material of claim 48, wherein the multilayer microporous film has the following structure in the following order:
a biaxially stretched microporous film;
a porous film having an average pore size of less than 0.1 microns or an entire pore distribution of less than 0.1 microns; and
a biaxially stretched microporous film and
optionally one or more of the following:
wherein at least one of the biaxially stretched microporous films is made by a dry-stretch process or by a beta-nucleation process, and/or
wherein at least one of the biaxially stretched films is a monolayer film, and/or
wherein at least one of the biaxially stretched films comprises a polypropylene homopolymer, a polypropylene copolymer, or polymer blend of polypropylene and at least one other polymer, and/or
wherein at least one of the biaxially stretched films comprises a polypropylene copolymer comprising 3 to 20% PE, providing improved hand to the material.

54. (canceled)

55. (canceled)

56. (canceled)

57. (canceled)

58. (canceled)

59. The material of claim 48, wherein material passes ASTM F1671 @ 60 in-lb.

60. A personal protective equipment (PPE) comprising the material of claim 48.

61. The PPE of claim 60, wherein the PPE is any one of a mask, a hat, a surgical cap, gloves, a hospital gown, scrubs, a jacket, a surgical shoe cover, a hazmat suit, a blanket, a surgical drape, a laboratory coat, a uniform, coveralls, a privacy curtain, a vest, an apron, a chemical protective suit, and a full body suit.

62. (canceled)

63. (canceled)

64. (canceled)

65. (canceled)

66. (canceled)

67. (canceled)

68. (canceled)

69. The PPE of claim 27, wherein the PPE is any one of Level 3 or Level 4 gowns, hoods, booties, drapes, masks, gloves, capes, etc. as such levels are described by the United States Centers for Disease Control (CDC).

70. (canceled)
